(19) United States
(12) Patent Application Publication
(10) Pub. No.: US 2006/0289429 A1
(43) Pub. Date: Dec. 28, 2006

(54) Drive circuit board and flat panel display apparatus having the same

(76) Inventor: Kwang Jin Jeong, Yongin-si (KR)

Correspondence Address: CHRISTIE, PARKER & HALE, LLP, PO BOX 7068, PASADENA, CA, 91109-7068, US

(21) Appl. No.: 11/445,009

(22) Filed: May 31, 2006

(30) Foreign Application Priority Data
Jun. 1, 2005 (KR) 10-2005-0046848

(51) Int. Cl. F27B 9/06; F27D 11/00

(52) U.S. Cl. 219/388

(57) ABSTRACT

A drive circuit board and a flat panel display apparatus having the same includes a printed circuit board (PCB), a plurality of circuit devices connected to the PCB, and at least one radiation member positioned between the circuit devices to absorb heat generated by the circuit devices and to radiate the heat to surroundings of the radiation member. The circuit devices are positioned on opposite sides of the radiation member.

### CROSS REFERENCE TO RELATED APPLICATION

This application claims priority to and the benefit of Korean Patent Application No. 10-2005-0046848, filed Jun. 1, 2005 in the Korean Intellectual Property Office, the entire content of which is incorporated herein by reference.

### BACKGROUND OF THE INVENTION

A typical plasma display panel (PDP) includes a filter assembly, a panel, a heat-conducting sheet, a frame, a printed circuit board (PCB), and various accessories, which are contained inside front and rear cases.

The panel has a plurality of electrodes for discharge and discharge cells to generate display discharge by means of the electrodes, barriers, and fluorescent substances. Drive signals supplied to the electrodes are generated by drive units of the PCB positioned between the heat-conducting sheet and the frame in the rearward direction of the panel.

The PCB includes a power supply unit for supplying power necessary to operate the PDP and create drive signals, addresses, scan and sustain drive units for supplying the electrodes with different drive signals, and a buffer board for transmitting signals from them to the panel.

The drive units on the PCB are connected to the electrodes of the panel by a plurality of cable members. As the cable members, a flexible printed circuit (FPC) and tape carrier packages (TCPs) which have a drive chip mounted on a film-type connection member are commonly used. Such flexible cable members bypass the heat-conducting sheet and the frame and connect the drive units on the PCB to the electrodes of the panel.

The PDP causes discharge at the panel, which has electrodes and dielectric substances formed thereon, and displays images. In the panel, components including electrodes and dielectric substances are positioned between at least two glass substrates and the inner space is filled with inert gases. The inert gases are transformed into charged particles during discharge and UV rays created during this time excite fluorescent substances and generate visible rays. However, very high voltage is necessary to realize images using this method. Particularly, a large amount of energy must be supplied as drive signals of relatively high voltage, in order to transform stable elements, such as inert gases, into charged particles.

Such high-voltage drive signals are burdens not only to the electrodes on the panel, but also to the drive circuits on the PCB. Such burdens usually cause vibration, noise, and heating. Therefore, resulting problems related to erroneous operation and device fracture remain as the key issue to be addressed.

FIG. 1 is a sectional view showing a conventional field effect transistor (FET) drive circuit board. The drive circuit board 1 has a plurality of FETs 20 connected to a PCB 10 and a radiation plate 50 positioned between the respective FETs 20 to absorb heat generated by them and to emit the heat to its surroundings.

However, such a conventional FET drive circuit board has a problem in that a plurality of FETs 20 are in surface-contact with only a side of the radiation plate 50.

As electrical currents flow through various circuit devices connected to the PCB, magnetic fields are created by the currents. In addition, an external magnet, such as a magnet used in a speaker, may add to the magnetic fields.

As electrical currents flow through the respective FETs 20 along corresponding leads 25, each FET 20 is subjected to an electromagnetic force under the influence of the magnetic fields. The electromagnetic force causes each FET 20 to vibrate and generate noise. Since a plurality of FETs are in surface-contact with only a side of the radiation plate 50 vibrations from the respective FETs 20 accumulate and worsen the vibration and noise problem.

### SUMMARY OF THE INVENTION

A drive circuit board according to one embodiment of the invention includes a printed circuit board (PCB); a plurality of circuit devices connected to the PCB; and at least one radiation member positioned between the circuit devices to absorb heat generated by the circuit devices and to radiate the heat to surroundings of the radiation member. The circuit devices are positioned on opposite sides of the radiation member. In one embodiment, the circuit devices are symmetrically positioned about the radiation member.

The radiation member may have longer sides and shorter sides and the circuit devices may be positioned on the longer sides of the radiation member. In one embodiment, the radiation member includes a base in surface-contact with the PCB and an extension having a plurality of fins extending from the base.

In another embodiment, at least one of the circuit devices is in contact with a first side of the radiation member and at least one of the circuit devices is in contact with a second side of the radiation member. The radiation member in this embodiment includes a first radiation unit having a plurality of first radiation fins extending in a direction substantially perpendicular to a direction of alignment of the at least one of the circuit devices in contact with the first side of the radiation member; a first coupling unit coupling the first radiation fins while being in surface-contact with the at least one of the circuit devices in contact with the first side; a second radiation unit having a plurality of second radiation fins extending in a direction substantially perpendicular to a direction of alignment of the at least one of the circuit devices in contact with the second side; and a second coupling unit coupling the plurality of second radiation fins while being in surface-contact with the at least one of the circuit devices in contact with the second side. At least one of the first radiation fins and at least one of the second radiation fins in this embodiment are connected to each other. The first radiation unit and the second radiation unit may be symmetrically positioned. In another embodiment, a topmost one of the first radiation fins is connected to a topmost one of the second radiation fins.

In yet another embodiment, a flat panel display apparatus includes a frame; a panel attached to the front surface of the frame; and a drive circuit board having a PCB fixed to a rear surface of the frame and connected to the panel to drive the PCB. The drive circuit board may be as described above.

### BRIEF DESCRIPTION OF THE DRAWINGS

The above and other features and aspects of the present invention will be more apparent from the following detailed description taken in conjunction with the accompanying drawings, in which:

FIG. 1 is a sectional view showing a conventional FET drive circuit board;

FIG. 2 is a schematic exploded perspective view showing a plasma display apparatus having a drive circuit board according to an embodiment of the present invention;

FIG. 3a is a perspective view showing a drive circuit board according to an embodiment of the present invention, which has a plurality of circuit devices attached to both sides of a radiation member;

FIG. 3b is a sectional view taken along line A-A of the drive circuit board shown in FIG. 3a;

FIG. 3c is a top view of the drive circuit board shown in FIG. 3a;

FIG. 4a is a perspective view showing a drive circuit board according to another embodiment of the present invention, which has a plurality of circuit devices attached to both sides of a radiation member;

FIG. 4b is a sectional view taken along line B-B of the drive circuit board shown in FIG. 4a; and

FIG. 4c is a top view of the drive circuit board shown in FIG. 4a.

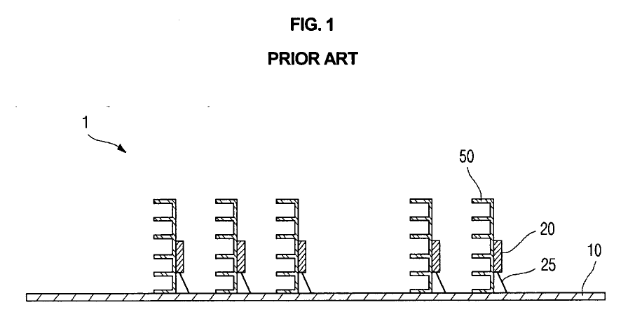

### DETAILED DESCRIPTION

Hereinafter, various embodiments of the present invention will be described with reference to the accompanying drawings. In the following description and drawings, the same reference numerals are used to designate the same or similar components, and repetition of the description of the same or similar components will be omitted.

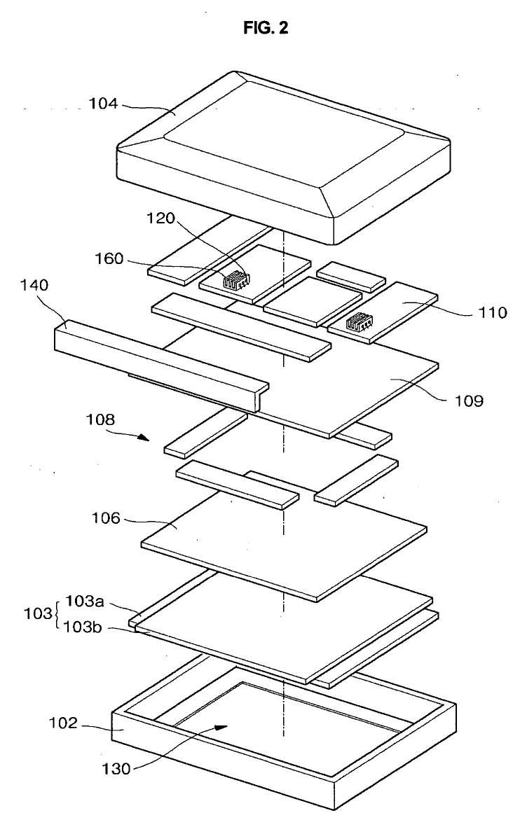

FIG. 2 is a schematic exploded perspective view showing a plasma display apparatus having a drive circuit board according to an embodiment of the present invention. The plasma display device includes a front case 102, a rear case 104, a panel 103, a heat-conducting sheet 106, adhesion members 108, a frame 109, a PCB 110, a protective plate 140, and a radiation member 160.

The front case 102 is fastened to the rear case 104 and protects the panel 103, the heat-conducting sheet 106, the adhesion members 108, the frame 109, and the PCB 110, which are positioned therein, from external contaminants and various impacts. It also prevents noise and vibration from being transmitted to the user, which are generated when the PDP is driven. The frame 109 may have a fixing member formed thereon to fix it. In this case, the front case 102 is fastened to the fixing member and retains the heat-conducting sheet 106, the adhesion members 108, and the panel 103 more rigidly, which are inserted between the front case 102 and the frame 109. The front case 102 has an optical transmission unit 130 formed thereon so that light from the panel 103 can be emitted to the exterior. A filter assembly (not shown) may be inserted between the optical transmission unit 130 and the panel 103. The filter assembly includes a color correction film for removing a part of visible rays from the panel 103 and correcting the color, an electromagnetic wave interruption film for interrupting electromagnetic waves created when the PDP is driven, and an anti-reflection film for preventing screen quality from degrading due to reflection of inner and outer light.

The rear case 104 is coupled to the front case 102 and protects inner components from external contaminants and impacts. The rear case 104 has a vent to emit inner heat to the exterior. The rear case 104 may be used as the ground source for drive circuits formed on the PCB 110.

The panel 103 displays images by means of discharge generated by drive signals supplied from a drive unit formed on the PCB 110. To this end, the panel 103 has a barrier, an electrode, a fluorescent substance, a dielectric substance, a protective film, and the like formed between at least two substrates 103a and 103b to provide a discharge cell in which discharge can occur. The discharge cell is filled with an inert gas which emits UV rays in a wavelength band that excites the fluorescent substance during discharge. The panel 103 is connected to the drive unit of the PCB 110 by a connection member, such as an FPC or a chip-on-film type TCP having some drive chips mounted thereon. The panel 103 may have accessories attached to the rear surface thereof, such as the adhesion members 108 and the heat-conducting sheet 106.

The heat-conducting sheet 106 is inserted between the panel 103 and the frame 109 and transmits heat generated by the panel 103 to the frame 109 when the PDP is driven or radiates the heat to prevent the temperature of the panel 103 from rising abruptly. The heat-conducting sheet 106 regulates the irregular temperature distribution of the panel 103 and prevents the panel 103 from fracturing or functioning erroneously due to local temperature difference. The attachment method and role of the heat-conducting sheet 106, in one embodiment, are determined based on the material of the frame 109 for proper operation of the PDP. For example, when the frame 109 is made of a material having good heat-conducting and heat-radiating properties, such as metal, the heat-conducting sheet 106 is closely fastened to the frame 109. In this case, a substantial amount of heat generated by the panel 103 is transmitted to the frame 109 via the heat-conducting sheet 106 to be radiated while a portion thereof is radiated by the heat-conducting sheet 106. When the frame 109 is made of a material having poor heat-conducting and heat-radiating properties, such as plastic, the heat-conducting sheet 106 and the frame 109 are positioned with a predetermined spacing. In this case, almost all heat generated by the panel 103 is radiated by the heat-conducting sheet 106 so that the temperature of the panel 103 remains constant.

The adhesion members 108 fix the heat-conducting sheet 106 or the panel 103 to the frame 109. To this end, the adhesion members 108 are formed along the edges of the heat-conducting sheet 106 in the shape of a stripe or picture frame, as shown in FIG. 2. The adhesion members 108 may be made of an adhesive, an adhesion sheet, or an adhesion tape. The attachment method, thickness, and shape of the adhesion members 108, in one embodiment, are determined based on the characteristics of the frame 109. When the frame 109 is made of a material having poor heat-conducting and heat-radiating properties, as mentioned above, the adhesion members 108 may be spaced from each other. This is for the purpose of circulating air through the space between the adhesion members 108 and facilitating radiation of the heat-conducting sheet 106. In one embodiment, even when the adhesion members 108 directly attach the panel 103 to the frame 109, the thickness of the adhesion members 108 is increased and a gap is provided through which air can circulate for radiation of the heat-conducting sheet 106. When the frame 109 is made of a material having good heat-conducting and heat-radiating properties, in contrast, the shape and form of the adhesion members 108 may be determined in such a manner that the heat-conducting sheet 106 and the frame 109 can be closely fastened to each other.

The frame 109 retains the panel 103 or the heat-conducting sheet 106 using the adhesion members 108. According to the material, the frame 109 may radiate heat from the panel 103, the PCB 110, and the TCP. The frame 109 supports and retains the PCB 110 with a fastening means, such as a boss or screw. Whether the frame 109 is closely fastened to the heat-conducting sheet 10 or not depends on its material, as mentioned above. When the frame 109 is made of metal, it may be used as the ground source for a part of the drive circuits formed on the PCB 110. The frame 109 may have a fixing member formed on its edge or corner to fix the front or rear case 102 or 104 thereto.

The PCB 110 has various circuit units formed thereon to drive the PDP while being distributed on various segments of substrates. Particularly, the PCB 110 includes a power supply unit, a logic circuit unit, an address drive unit, a scan drive unit, a sustain drive unit, and drive buffer boards. The power supply unit supplies the drive circuits and the panel with electric power and has an AC/DC converter mounted thereon to convert AC voltage supplied from the exterior into DC voltage. The logic circuit unit receives image signals and classifies and controls signals to be sent to the address drive unit, the scan drive unit, and the sustain drive unit. It also adjusts electric power automatically. Each drive unit receives a signal from the logic circuit and transmits it to each drive chip, which distributes commands from the logic circuit to each electrode. The drive buffer boards are positioned between each drive board and the panel 103 so that drive signals from each drive unit are transmitted to the panel 103 via the drive buffer boards. The drive buffer boards are connected to the panel 103 by a TCP or FPC. The substrate, which has an address drive unit, a scan drive unit, and a sustain drive unit formed thereon, has an FET 120 mounted thereon to convert electric power supplied from the power supply unit into drive signals according to drive signals of the drive units.

The protective plate 140 protects the TCP from external impacts together with the front and rear cases 102 and 104. It transmits heat generated by the TCP to a radiation member 160 and radiates a part of it to prevent the TCP from fracturing or functioning erroneously. To this end, a surface of the protective plate 120 is closely fastened to the drive chip of the TCP and the other side has the radiation member fixed thereto.

The radiation member 160 radiates heat from major heating devices, including the drive chip of the TCP and the FET, and prevents them from fracturing or functioning erroneously. The interconnection between the radiation member 160 and a plurality of FETs will now be described in detail.

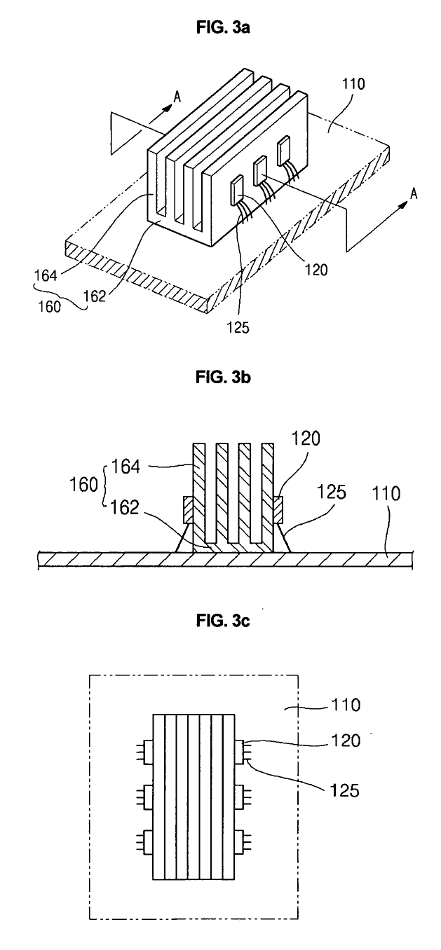

FIG. 3a is a perspective view showing a drive circuit board according to an embodiment of the present invention, which has a plurality of circuit devices attached to both sides of a radiation member. FIG. 3b is a sectional view taken along line A-A of the drive circuit board shown in FIG. 3a. FIG. 3c is a top view of the drive circuit board shown in FIG. 3a.

The drive circuit board includes a PCB 110, a plurality of circuit devices 120 connected to the PCB 110, and at least one radiation member 160 positioned between the circuit devices 120 to absorb heat generated by the circuit devices 120 and to emit the heat to the surroundings. The circuit devices 120 are positioned on both opposite sides of the radiation member 160. In the drawings, three circuit devices 120 are shown to be positioned on each longer side of the radiation member 160 and, consequently, a total of six circuit devices 120, for example, FETs are symmetrically positioned on both sides of the radiation member 160.

The radiation member 160 includes a base 162 in surface-contact with the PCB 110 and an extension 164 having a plurality of fins extending from the base 162. The angle between each fin of the extension 164 and the base 162 is 90°. Heat generated by the circuit devices 120 is transmitted to the fins on both ends of the extension 164. Particularly, a part of the heat is transmitted to adjacent fins via the base 162 or through the air to be radiated and the remaining part is directly radiated from the fins on both ends of the extension 164.

As electrical currents flow through various circuit devices connected to the PCB, magnetic fields are created by the currents. In addition, an external magnet, such as a magnet used in a speaker, may add to the magnetic fields.

As electrical currents flow through the respective FETs 120 along corresponding leads 125, each FET 120 is subjected to an electromagnetic force under the influence of the magnetic fields. The electromagnetic force may cause each FET 120 to vibrate and generate noise.

However, vibrations of the circuit devices 120 due to electromagnetic forces counterbalance one another without generating any noise, because, unlike conventional drive circuit boards having a plurality of circuit devices in surface-contact with only a side of the radiation member, three circuit devices are positioned on each longer side of the radiation member 160 and, consequently, a total of six circuit devices are symmetrically positioned on both sides of the radiation member 160 according to this embodiment of the present invention.

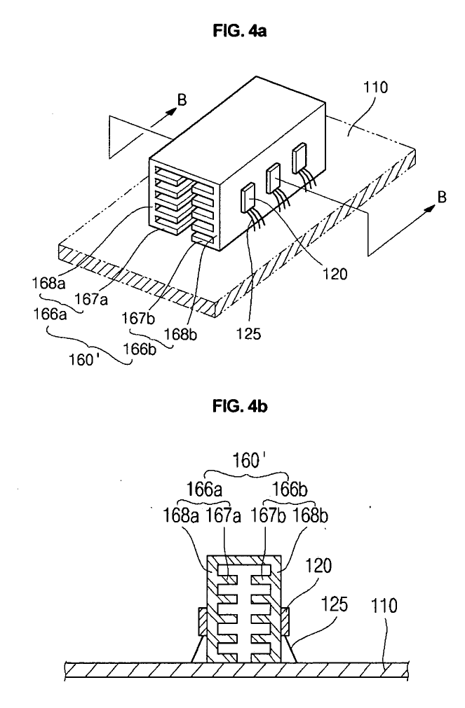

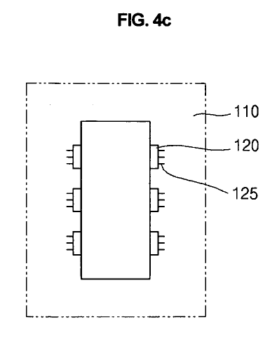

FIG. 4a is a perspective view showing a drive circuit board according to another embodiment of the present invention, which has a plurality of circuit devices attached to both sides of a radiation member. FIG. 4b is a sectional view taken along line B-B of the drive circuit board shown in FIG. 4a. FIG. 4c is a top view of the drive circuit board shown in FIG. 4a. The drive circuit board includes a PCB 110, a plurality of circuit devices 120 connected to the PCB 110, and at least one radiation member 160′ positioned between the circuit devices 120 to absorb heat generated by the circuit devices 120 and to emit the heat to the surroundings. The circuit devices 120 are positioned on both opposite sides of the radiation member 160. In the drawings, three circuit devices 120 are shown to be positioned on each longer side of the radiation member 160′ and, consequently, a total of six circuit devices 120, for example, FETs are symmetrically positioned on both sides of the radiation member 160′.

The radiation member 160′ includes first and second radiation units 166a and 166b. The first radiation unit 166a of the radiation member 160′ includes a plurality of first radiation fins 167a which are perpendicular to circuit devices that are in contact with a side of the radiation member 160′ and a first coupling unit 168a which couples the first radiation fins 167a while being in surface-contact with the circuit devices. The second radiation unit 166b of the radiation member 160′ includes a plurality of second radiation fins 167b which are perpendicular to circuit devices that are in contact with the other side of the radiation member 160′ and a second coupling unit 168b which couples the second radiation fins 167b while being in surface-contact with the circuit devices. At least one first and second radiation fins 167a and 167b are connected to each other.

In one embodiment, the first and second radiation units 166a and 166b are symmetrically formed to avoid vibration and noise. In the drawing, only the topmost one of the first radiation fins 167a is connected to the topmost one of the second radiation fins 167b. The angle between the radiation fins 167a and 167b and the coupling units 168a and 168b is 90°. Heat generated by the circuit devices 120 is transmitted to the coupling units 168a and 168b. A part of the heat is transmitted to the respective radiation units 167a and 167b to be radiated and the remaining part thereof is directly radiated from the coupling units 168a and 168b.

As electrical currents flow through various circuit devices connected to the PCB, magnetic fields are created by the currents. In addition, an external magnet, such as a magnet used in a speaker, may add to the magnetic fields.

As electrical currents flow through the respective FETs 120 along corresponding leads 125, each FET 120 is subjected to an electromagnetic force under the influence of the magnetic fields. The electromagnetic force may cause each FET 120 to vibrate and generate noise.

However, vibrations of the circuit devices 120 due to electromagnetic forces counterbalance one another without generating any noise, because, unlike conventional drive circuit boards having a plurality of circuit devices in surface-contact with only a side of the radiation member, three circuit devices are positioned on each longer side of the radiation member 160′ and, consequently, a total of six circuit devices are symmetrically positioned on both sides of the radiation member 160′ according to this embodiment of the present invention.

Although the present invention has been described with reference to a PDP, the present invention is applicable to other types of flat panel display apparatuses.

The drive circuit board according to above described embodiments of the present invention and a flat panel display apparatus having the same are advantageous in that a plurality of circuit devices are positioned on both sides of a radiation member so that vibrations of the circuit devices caused by electromagnetic forces counterbalance one another to avoid noise generation.

Although various embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. A drive circuit board comprising:
a printed circuit board (PCB);
a plurality of circuit devices connected to the PCB; and
at least one radiation member positioned between the circuit devices to absorb heat generated by the circuit devices and to radiate the heat to surroundings of the radiation member, wherein
the circuit devices are positioned on opposite sides of the radiation member.

2. The drive circuit board as claimed in claim 1, wherein the circuit devices are symmetrically positioned about the radiation member.

3. The drive circuit board as claimed in claim 1, wherein the radiation member has longer sides and shorter sides and the circuit devices are positioned on the longer sides of the radiation member.

4. The drive circuit board as claimed in claim 1, wherein the radiation member comprises a base in surface-contact with the PCB and an extension having a plurality of fins extending from the base.

5. The drive circuit board as claimed in claim 1, wherein at least one of the circuit devices is in contact with a first side of the radiation member and at least one of the circuit devices is in contact with a second side of the radiation member, and wherein the radiation member comprises:
a first radiation unit having a plurality of first radiation fins extending in a direction substantially perpendicular to a direction of alignment of the at least one of the circuit devices in contact with the first side of the radiation member;
a first coupling unit coupling the first radiation fins while being in surface-contact with the at least one of the circuit devices in contact with the first side;
a second radiation unit having a plurality of second radiation fins extending in a direction substantially perpendicular to a direction of alignment of the at least one of the circuit devices in contact with the second side; and
a second coupling unit coupling the plurality of second radiation fins while being in surface-contact with the at least one of the circuit devices in contact with the second side,
wherein at least one of the first radiation fins and at least one of the second radiation fins are connected to each other.

6. The drive circuit board as claimed in claim 5, wherein the first radiation unit and the second radiation unit are symmetrically positioned.

7. The drive circuit board as claimed in claim 5, wherein a topmost one of the first radiation fins is connected to a topmost one of the second radiation fins.

8. A flat panel display apparatus comprising:
a frame;
a panel attached to the front surface of the frame; and
a drive circuit board having a printed circuit board (PCB) fixed to a rear surface of the frame and connected to the panel to drive the PCB, a plurality of circuit devices connected to the PCB, and at least one radiation member positioned between the circuit devices to absorb heat generated by the circuit devices and to radiate the heat to surroundings of the radiation member,
wherein the circuit devices are positioned on opposite sides of the radiation member.

9. The flat panel display apparatus as claimed in claim 8, wherein the circuit devices are symmetrically positioned about the radiation member.

10. The flat panel display apparatus as claimed in claim 8, wherein radiation member has longer sides and shorter sides, and wherein the circuit devices are positioned on the longer sides of the radiation member.

11. The flat panel display apparatus as claimed in claim 8, wherein the radiation member comprises a base in surface-contact with the PCB and an extension having a plurality of fins extending from the base.

12. The flat panel display apparatus as claimed in claim 8, wherein at least one of the circuit devices is in contact with a first side of the radiation member and at least one of the circuit devices is in contact with a second side of the radiation member, and wherein the radiation member comprises:
a first radiation unit having a plurality of first radiation fins extending in a direction substantially perpendicular to a direction of alignment of the at least one of the circuit devices in contact with the first side of the radiation member;
a first coupling unit coupling the first radiation fins while being in surface-contact with the at least one of the circuit devices in contact with the first side;
a second radiation unit having a plurality of second radiation fins extending in a direction substantially perpendicular to a direction of alignment of the at least one of the circuit devices in contact with the second side; and
a second coupling unit coupling the plurality of second radiation fins while being in surface-contact with the at least one of the circuit devices in contact with the second side,
wherein at least one of the first radiation fins and at least one of the second radiation fins are connected to each other.

13. The flat panel display apparatus as claimed in claim 12, wherein the first radiation unit and the second radiation unit are symmetrically positioned.

14. The flat panel display apparatus as claimed in claim 12, wherein a topmost one of the first radiation fins is connected to a topmost one of the second radiation fins.
